(19) United States
(12) Patent Application Publication
(10) Pub. No.: US 2026/0100647 A1
(43) Pub. Date: Apr. 9, 2026

(54) CONTROLLER FOR MULTI-PHASE SWITCHING CONVERTER

(71) Applicant: Renesas Design (UK) Limited, Bourne End (GB)

(72) Inventors: Shu WU, Tokyo (JP); Keisuke KADOWAKI, Tokyo (JP); Davide BIANCHI, Swindon (GB)

(73) Assignee: Renesas Design (UK) Limited, Bourne End (GB)

(21) Appl. No.: 18/905,415

(22) Filed: Oct. 3, 2024

(51) Int. Cl. H02M 3/158

(52) U.S. Cl. CPC H02M 3/1584

(57) ABSTRACT

A controller for a multi-phase switching converter including multiple phase circuits is provided. The multi-phase switching converter is configured to receive an input voltage, generate an output voltage, and provide a load current. The controller includes a current threshold generator configured to generate a first threshold current that is dependent on the input voltage and/or the output voltage, a comparator system configured to compare the load current to the first threshold current, and a phase control system configured to change the number of active phase circuits based on the comparison between the load current and the first threshold current.

### BACKGROUND

The present disclosure relates to a controller for a multi-phase switching converter.

FIG. 1A is a schematic of a multi-phase switching converter 100 which comprises a plurality of phase circuits 102, 104, 106, 108. The phase circuits 102-108 are coupled in parallel, and each phase circuit 102-108 comprises a single switching converter. In the present example, the multi-phase switching converter 100 is a 4-phase multi-phase buck converter, such that each phase circuit 102-108 comprises a buck converter.

The multi-phase switching converter 100 further comprises an output capacitor 110, and, during operation, receives an input voltage V_IN and generates an output voltage V_OUT. A load current Iload may be provided to an electrical load provided by the output capacitor 110.

The phase circuits 102-108 may be enabled or disabled during operation of the multi-phase switching converter 100, to optimise the operation of the converter 100 for different load current Iload conditions.

FIG. 1B is a graph 112 showing the operating efficiency versus the load current Iload (labelled as “Output Load”) for one active phase circuit (a trace 114), for two active phase circuits (a trace 115) and for four active phase circuits (a trace 116).

It can be observed that at a transition point 118 it is beneficial to change the number of active phase circuits 102-108 depending on the load current. For example, if currently operating with a single phase, and the load current increases beyond the transition point 118 the operating efficiency can be improved by activating a further phase circuit. Similarly, if two phase circuits 102-108 are currently active, and the load current falls below the transition point, the operating efficiency can be improved by disabling one of the phase circuits 102-108. A further transition point between two and four active phase circuits 102-108 is shown at a transition point 120.

The deactivation and activation of phase circuits 102-108 may be referred to as phase shedding and phase adding, respectively. In known systems the multi-phase switching converter 100 may exhibit auto phase shedding/adding based on a measurement of the load current and comparison with a fixed threshold condition.

For high-power applications, known multi-phase buck power converters 100 can achieve high operational efficiency at a high load condition. To improve overall efficiency along the entire operating load range, known multi-phase buck converters automatically add or shed the number of phases according to the load current. Unused phase circuits 102-108 may be set to a high impedance (HiZ) output, so as not to load the output voltage V_OUT.

### SUMMARY

It is desirable to provide an improved multi-phase switching converter system over different operating conditions.

According to a first aspect of the disclosure there is provided a controller for a multi-phase switching converter comprising a plurality of phase circuits, wherein the multi-phase switching converter is configured to receive an input voltage, generate an output voltage, and provide a load current, and the controller comprising a current threshold generator configured to generate a first threshold current that is dependent on the input voltage and/or the output voltage, a comparator system configured to compare the load current to the first threshold current, and a phase control system configured to change the number of active phase circuits based on the comparison between the load current and the first threshold current.

Optionally, the first threshold current is dependent on the number of currently active phase circuits.

Optionally, the phase control system is configured to change the number of active phase circuits based on the comparison between the load current and the first threshold current by enabling one or more of the phase circuits, and/or disabling one or more of the phase circuits.

Optionally, the phase control system is configured to change the number of active phase circuits based on the comparison between the load current and the first threshold current by enabling one or more of the phase circuits when the load current becomes greater than the first threshold current, and/or disabling one or more of the phase circuits when the load current becomes less than the first threshold current.

Optionally, the current threshold generator is configured to generate a second threshold current that is dependent on the input voltage and/or the output voltage, the comparator system is configured to compare the load current to the second threshold current, and the phase control system is configured to change the number of active phase circuits based on the comparison between the load current and the second threshold current.

Optionally, the second threshold current is greater than the first threshold current.

Optionally, the first threshold current is dependent on the number of currently active phase circuits, and/or the second threshold current is dependent on the number of currently active phase circuits.

Optionally, the phase control system is configured to change the number of active phase circuits based on the comparison between the load current and the first threshold current by enabling one or more of the phase circuits, and/or disabling one or more of the phase circuits, and change the number of active phase circuits based on the comparison between the load current and the second threshold current by enabling one or more of the phase circuits, and/or disabling one or more of the phase circuits.

Optionally, the phase control system is configured to change the number of active phase circuits based on the comparison between the load current and the first threshold current by enabling one or more of the phase circuits when the load current becomes greater than the first threshold current, and/or disabling one or more of the phase circuits when the load current becomes less than the first threshold current, and change the number of active phase circuits based on the comparison between the load current and the second threshold current by enabling one or more of the phase circuits when the load current becomes greater than the second threshold current, and/or disabling one or more of the phase circuits when the load current becomes less than the second threshold current.

Optionally, the multi-phase switching converter is a multi-phase buck converter, boost converter, or buck-boost converter.

Optionally, the controller comprises a voltage sensing unit configured to sense the input voltage and/or the output voltage.

Optionally, the voltage sensing unit comprises a resistor divider configured to sense the input voltage and to provide the sensed input voltage to the current threshold generator.

Optionally, the current threshold generator comprises a current regulator configured to receive the sensed input voltage, and a first current mirror comprising one or more current sources, wherein the first current mirror is coupled to the current regulator, and the first current mirror is configured to provide the first threshold current to the comparator system.

Optionally, the first current mirror comprises a gain selection transistor for setting a gain value, the first threshold current being dependent on the gain value.

Optionally, the one or more current sources comprises a trimming current source for trimming the first threshold current value, a hysteresis current source configured to adjust the first threshold current based on the number of currently active phase circuits, and/or a voltage adjustment current source for adjusting the first threshold current based on the output voltage.

Optionally, the multi-phase switching converter is configured to generate the output voltage that is dependent on a reference voltage, and the voltage sensing unit comprises a threshold current offset signal generator configured to receive the reference voltage, and generate a threshold current offset signal using the reference voltage, and the voltage adjustment current source is configured to adjust the first threshold current based on the output voltage using the threshold current offset signal.

Optionally, the phase control system comprises a debouncing circuit configured to control the hysteresis current source.

Optionally, the controller comprises a current measurement system configured to determine the load current by measuring an average current flow in each of the phase circuits, summing together the average current flows as measured, the load current being the sum of the average current flows as measured, and providing the load current to the comparator system.

Optionally, the multi-phase switching converter is configured to generate the output voltage that is dependent on a reference voltage, and the current threshold generator is configured to generate the first threshold current that is dependent on the reference voltage and thereby is dependent on the output voltage.

Optionally, the phase control system comprises a finite state machine.

According to a second aspect of the disclosure there is provided a method of controlling a multi-phase switching converter comprising a plurality of phase circuits and being configured to receive an input voltage, generate an output voltage and provide a load current, the method comprising generating a first threshold current that is dependent on the input voltage and/or the output voltage using a current threshold generator, comparing the load current to the first threshold current using a comparator system, and changing the number of active phase circuits based on the comparison between the load current and the first threshold current using a phase control system.

It will be appreciated that the method of the second aspect may include providing and/or using features set out in the first aspect and can incorporate other features as described herein.

### BRIEF DESCRIPTION OF THE DRAWINGS

The disclosure is described in further detail below by way of example and with reference to the accompanying drawings, in which:

FIG. 1A is a schematic of a multi-phase switching converter;

FIG. 1B is a graph showing the operating efficiency versus the load current for one, two and four active phase circuits;

FIG. 2 is a graph showing the operating efficiency versus the load current for the multi-phase converter of FIG. 1A;

FIG. 3A is a schematic of a controller for a multi-phase switching converter in accordance with a first embodiment of the present disclosure;

FIG. 3B is a graph showing an example of the phase activation/deactivation conditions provided by the controller during operation of the multi-phase switching converter;

FIG. 4A is a schematic of a specific embodiment of the controller in accordance with a second embodiment of the present disclosure;

FIG. 4B is a schematic of a specific embodiment of the controller in accordance with a third embodiment of the present disclosure;

FIG. 4C is a schematic of a specific embodiment of the output voltage sensor; and

FIG. 4D is a graph showing the operating efficiency versus the load current for a practical implementation of the controller and multi-phase converter of FIG. 3A.

### DETAILED DESCRIPTION

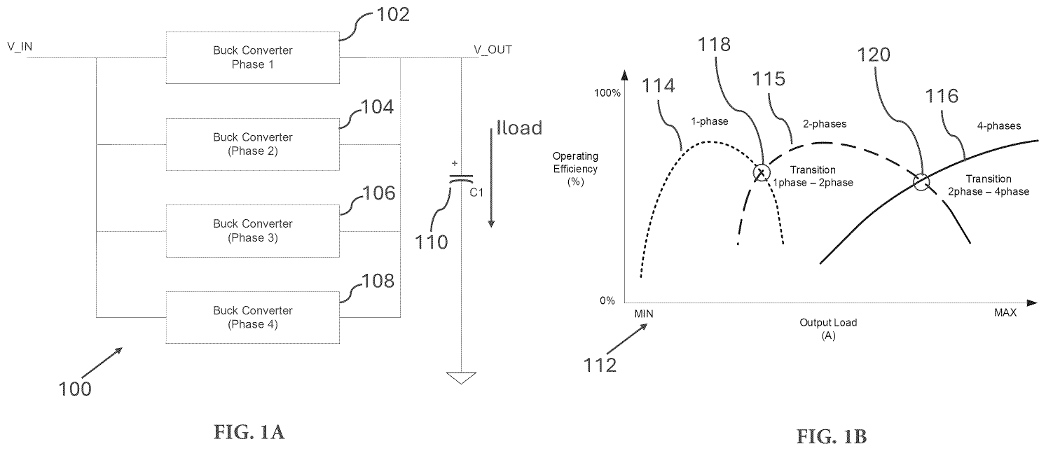

Known multi-phase converters (such as described in relation to FIG. 1A and FIG. 1B) set the fixed phase transition points after trimming and configuration, with the transition points then being stored in one-time-programmable memory (OTP). These transition points are fixed at a defined load current and optimized for specific parameters. The parameters may be, for example, input voltage and/or output voltage.

Considering an example where the transition points are fixed and optimised based on the input voltage-if the input voltage has a wide range, the hard coded transition points will result in sub-optimal system efficiency. For example, portable devices, where the input voltage source is the rechargeable battery, have a wide operating voltage range because the battery voltage will fall as the battery discharges.

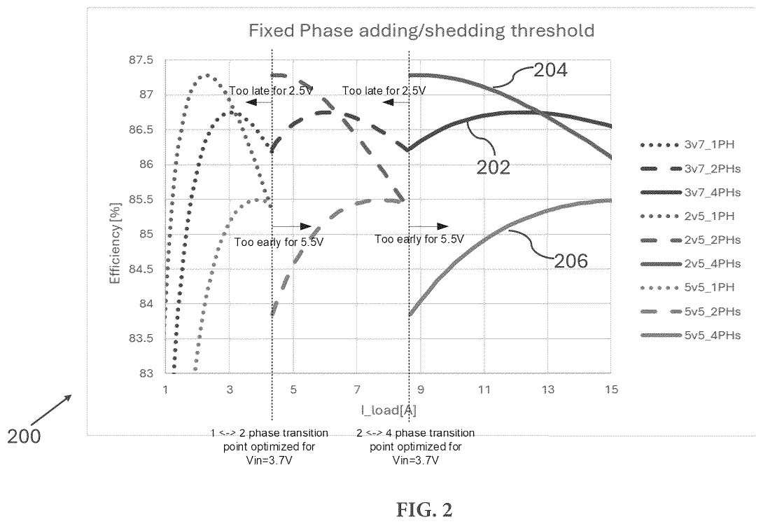

FIG. 2 is a graph 200 showing the operating efficiency versus the load current I load for the multi-phase converter 100 having transition points optimised for an input voltage of 3.7V. A trace 202 shows the efficiency curve for the input voltage being equal to 3.7V. A trace 204 shows the efficiency curve for the input voltage being 2.5V; and a trace 206 shows the efficiency curve for the input voltage being 5.5V.

The discontinuities in operational efficiency at the transition points on the traces 204, 206 demonstrate non-optimal operation of the converter 100 when the input voltage deviates from 3.7V. This is a result of the transition points being optimised for 3.7V and the converter 100 operating at input voltages outside this range.

For example, and with reference to the trace 204 where the input voltage is 2.5V, as the load current increases the transition points occur too late and the converter 100 does not operate at optimum operating efficiency. Similarly, and with reference to the trace 206 when the input voltage is 5.5V, as the load current increases the transition points occur too soon and the converter 100 does not operate at optimum operating efficiency.

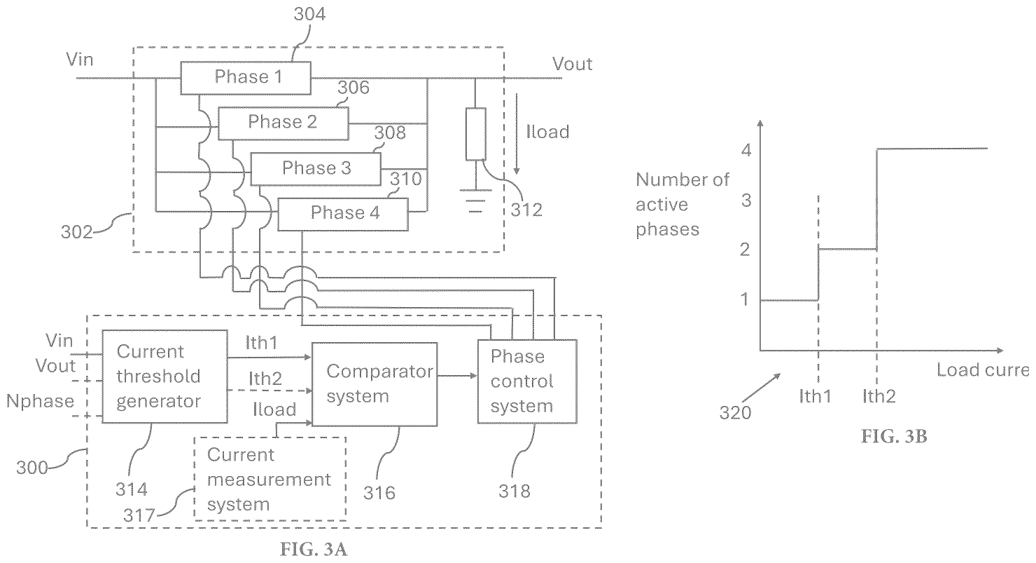

FIG. 3A is a schematic of a controller 300 for a multi-phase switching converter 302 in accordance with a first embodiment of the present disclosure. The multi-phase switching converter 302 comprises a plurality of phase circuits 304, 306, 308, 310.

In specific embodiments, the multi-phase switching converter 302 may be a multi-phase buck converter, boost converter, or buck-boost converter.

In the present example and in the following description, the multi-phase converter 302 comprises four phase circuits 304-310. However, it will be appreciated that in further embodiments the converter 302 may comprise more or fewer phase circuits.

The phase circuits 304-310 may be coupled in parallel. Each phase circuit 304-310 may comprise a single switching converter. For example, the multi-phase switching converter 302 may be a 4-phase multi-phase buck converter, such that each phase circuit 304-310 comprises a buck converter.

During operation the multi-phase converter 302 receives an input voltage Vin, generates an output voltage Vout and provides a load current Iload. In the present example, the output voltage Vout is coupled to an electrical load 312, with the load current Iload being provided to the electrical load 312.

The controller 300 comprises a current threshold generator 314 that is configured to generate a threshold current Ith1 that is dependent on the input voltage Vin and/or the output voltage Vout. The threshold current Ith1 may also be dependent on the number of currently active phase circuits 304-310, as illustrated by a signal Nphase being provided to the current threshold generator 314 in FIG. 3A. The number of phases currently being used may be fed back to the threshold current Ith1 to generate a hysteresis in the threshold Ith1 to avoid phase switching transition jitter.

The controller 300 further comprises a comparator system 316 that is configured to compare the load current Iload to the threshold current Ith1. The controller 300 further comprises a phase control system 318 that is configured to change the number of active phase circuits 304-310 based on the comparison performed by the comparator system 316. The phase control system 318 may comprise a logic circuit.

The controller 300 may comprise a current measurement 317 system that is configured to determine the load current Iload, for example to provide to the comparator system 316, by measuring an average current flow in each of the phase circuits 304-310, and adding together the average current flows. The load current Iload as provided to the comparator system 316 is the sum of the average current flows.

In a specific embodiment, the multi-phase converter 302 may generate the output voltage Vout that is dependent on a reference voltage. In a specific embodiment of the present disclosure, the current threshold generator 314 may be configured to generate the threshold current Ith1 that is dependent on the reference voltage and thereby is dependent on the output voltage Vout.

The changing of the number of active phase circuits 304-310 as performed by the phase control system 318 may, for example, be the enabling of one or more of the phase circuits 304-310 and/or the disabling of one or more of the phase circuits 304-310. In specific embodiments, and during operation, the phase control system 318 may enable one or more of the phase circuits 304-310 when the load current Iload becomes greater than the threshold current Ith1; and may disable one or more of the phase circuits 304-310 when the load current Iload becomes less than the threshold current Ith1.

FIG. 3B is a graph 320 showing an example of the phase activation/deactivation conditions provided by the controller 300 during operation of the multi-phase converter 302. In the present example, the threshold current Ith1 is the transition point between a single active phase circuit and two active phase circuits.

The current threshold generator 314 may be further configured to generate a threshold current Ith2 that is dependent on the input voltage Vin and/or the output voltage Vout. The comparator system 316 may be further configured to compare the load current Iload to the threshold current Ith2 and the phase control system 318 may be further configured to change the number of active phase circuits 304-310 based on the comparison. The threshold current Ith2 may be dependent on the number of currently active phase circuits. The changing of the number of active phase circuits 304-310 may be an enabling of more phase circuits, for example when the load current Iload exceeds the threshold current Ith2, and/or a disabling of phase circuits, for example when the load current Iload falls below the threshold current Ith2.

In the present example, the threshold current Ith2 is greater than the threshold current Ith1, with the threshold current Ith2 being the transition point between two active phase circuits and four active phase circuits.

It will be appreciated that in further embodiments the current threshold generator 314 may be configured to generate additional threshold current values, and the additional threshold current values may have one or more features as described in relation to the threshold currents Ith1, Ith2, in accordance with the understanding of the skilled person. Additionally, the controller 300 may function in relation to the additional threshold current values substantially as described for the current thresholds Ith1, Ith2, in accordance with the understanding of the skilled person. For example, for a further embodiment of the multi-phase converter 302 comprising five or more phase circuits, a further threshold current value may be greater than the current threshold Ith2 and may function as a transition point for the enabling/disabling of phases at higher load currents than provided by the current threshold Ith2.

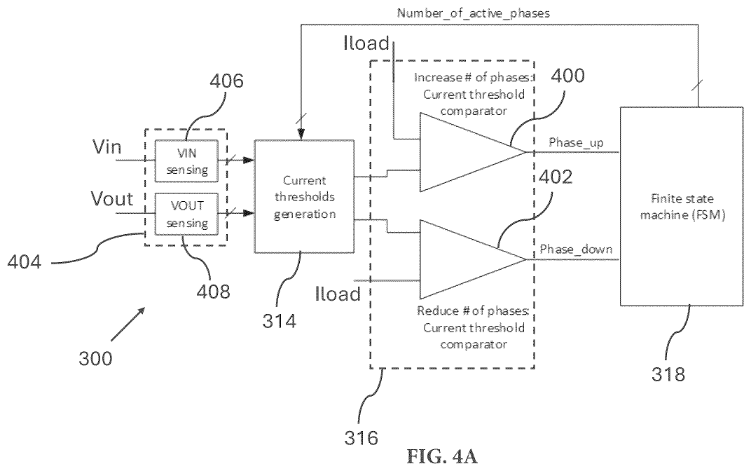

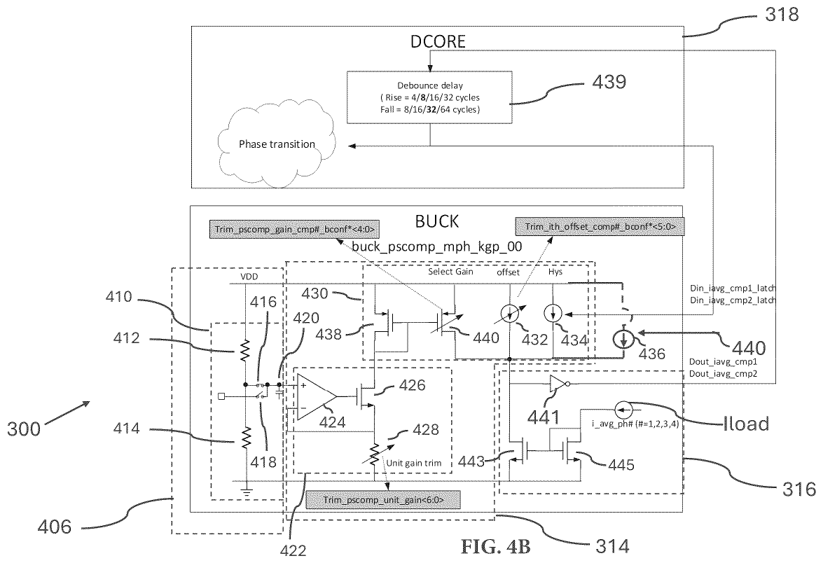

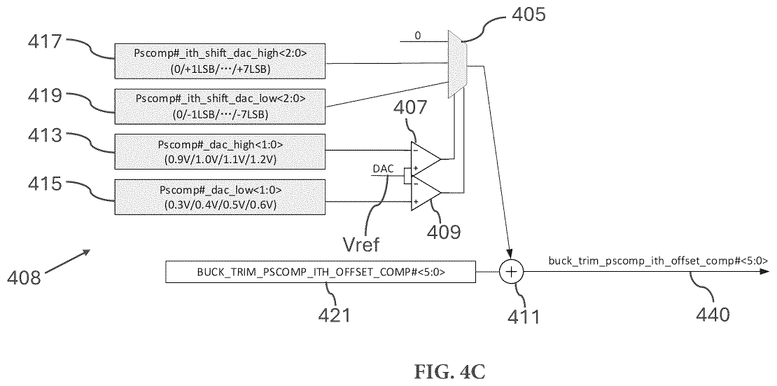

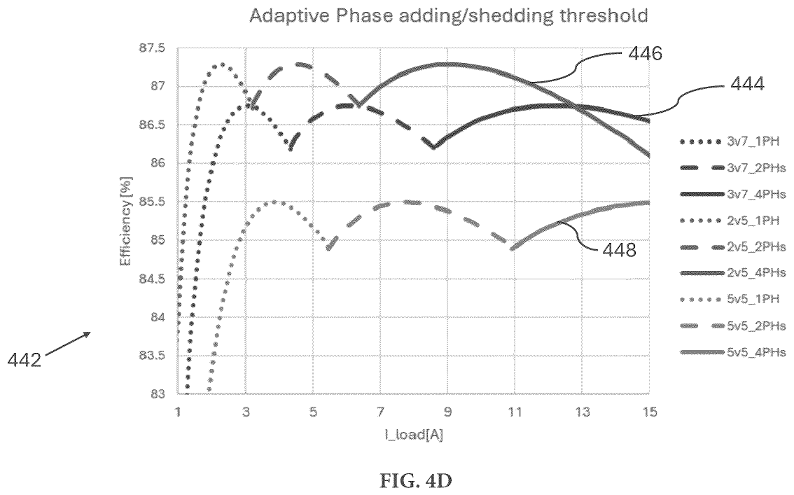

FIG. 4A is a schematic of a specific embodiment of the controller 300 in accordance with a second embodiment of the present disclosure. In the present example, the phase control system 318 comprises a finite state machine (FSM) and the comparator system 316 comprises comparators 400, 402.

In the present embodiment, the controller 300 comprises a voltage sensing unit 404 for sensing one or both of the input voltage Vin and the output voltage Vout. In the present example, the voltage sensing unit 400 comprises an input voltage sensor 406 and an output voltage sensor 408. The output voltage sensing may be provided by a digital set value rather than a specific voltage measurement.

FIG. 4B is a schematic of a specific embodiment of the controller 300 in accordance with a third embodiment of the present disclosure. The input voltage sensor 406 may comprise a resistor divider 410 that is configured to sense the input voltage Vin (labelled as VDD in the FIG. 4B) and to provide the sensed input voltage Vin to the current threshold generator 314. In the present embodiment, the resistor divider 410 comprises resistors 412, 414, switches 416, 418 and a capacitor 420.

The switches 416, 418 may be used to switch the current threshold back to a fixed value, as is the case in known systems. It will be appreciated that in further embodiments the switches 416, 418 may be omitted. In an embodiment where the switches 416, 418 have been omitted an output of the resistor divider 410 may, for example, be provided directly to the current threshold generator 314.

In the present embodiment, the current threshold generator 314 comprises a current regulator 422 that is configured to receive the sensed input voltage from the input voltage sensor 406. The current regulator 422 may comprise an amplifier 424, a transistor 426 and a variable resistor 428.

During operation, the amplifier 424 refers to the divided input voltage Vin and regulates a unit gain current to introduce the input voltage Vin information into the threshold current Ith1.

It will be appreciated that in further embodiments, where the switches 416, 418 are omitted, the output of the resistor divider 410 may be provided directly to an input of the amplifier 424.

The current threshold generator 314 may further comprise a current mirror 430 comprising one or more current sources. The current mirror 430 is coupled to the current regulator 422 and is configured to provide the threshold current Ith1 to the comparator system 316.

The current mirror comprises a transistor 438 and a gain selection transistor 440 for setting a gain value. The threshold current Ith1 may be dependent on the gain value.

In the present embodiment, the current mirror 430 comprises a trimming current source 432, a hysteresis current source 434, and a voltage adjustment current source 436. The trimming current source 432 may be used to trim the threshold current value Ith1. The hysteresis current source 434 is configured to adjust the threshold current Ith1 based on the number of currently active phase circuits. The voltage adjustment current source 436 is for adjusting the threshold current Ith1 based on the output voltage Vout.

It will be appreciated that in a further embodiment, the voltage adjustment current source 436 may be omitted thereby resulting in the threshold current Ith1 being dependent on the input voltage Vin, and not the output voltage Vout.

In the present embodiment, the phase control system 318 further comprising a debouncing circuit 439 that is configured to control the hysteresis current source 434. During operation, the debouncing circuit 439 provides the output of the comparator system 316 back to the comparator system 316 to enable hysteresis of the current threshold Ith1, thereby reducing the probability of continuous switching of phases at the current transition points.

In the present embodiment, the comparator system 316 comprises an inverter 441 and transistors 443, 445. The comparator system 316 may be referred to as a phase shedding comparator (PSCOMP).

During operation, the average current of each phase circuit 304-310 is measured and summed together to provide the sum of the average current “i_avg_ph#” which provides the load current Iload for use by the comparator system 316. The comparator system 316 compares the load current with the threshold current Ith1 to determine whether the load current is higher or lower than the threshold.

In known systems, the threshold current is fixed by trimming and configuration stored in OTP. The threshold current Ith1 in the present embodiment is proportional to the supply voltage VDD with, for example, a certain gain. The gain is different for different phase numbers. For example, the 1 phase to 2 phase transition has less gain than the 2 phase to 4 phase transition. According to an evaluation with silicon, the target gain for each case may be decided.

The unit gain (minimum gain) may be trimmed first. Then trimming the gain for the comparator system 316 may be trimmed for the different phase transitions (for example 1 phase-2 phase, and 2 phase-4 phase). Then the transition point may be adjusted to the expected load condition by the offset trimming.

The comparator system 316 outputs (labelled “Dout_iavg_cmp1” and “Dout_iavg_cmp2”) are sent to the digital core, which may be provided by the phase control system 318 and are used as buck finite state machine transition conditions to shed or add phases.

FIG. 4C is a schematic of specific embodiment of the output voltage sensor 408 for sensing the output voltage Vout as may be used with any of the embodiments of the controller 300 described herein in accordance with the understanding of the skilled person.

Although the optimal phase transition points show a smaller output voltage dependence, when compared with the input voltage dependence, the logic provided by the present embodiment and as may be implemented within the digital core, may be used to adjust the threshold current values when the output voltage is higher or lower than certain threshold voltage values.

The multi-phase converter 302 may generate the output voltage Vout that is dependent on a reference voltage Vref. In a specific embodiment of the present disclosure, the threshold current that is dependent on the output voltage Vout, may be generated using the reference voltage Vref. The multi-phase switching converter 302 may, for example, comprise a digital to analog converter (DAC) to provide the reference voltage Vref as the target for the output voltage Vout. The digital core may provide the reference voltage Vref.

In the present embodiment, output voltage sensor 408 is configured to receive the reference voltage Vref, and to generate a threshold current offset signal 440 using the reference voltage Vref. The voltage adjustment current source 436 is configured to adjust the threshold current Ith1 based on the output voltage Vout using the threshold current offset signal 440, thereby adjusting the threshold current Ith1 based on the output voltage Vout. The reference voltage Vref may be provided by the DAC code, the DAC code being equal to the multi-phase switching converter's 302 target output voltage.

In the present embodiment the output voltage sensor 408 comprises a multiplexer 405, comparators 407, 409, a summing circuit 411, voltage threshold generators 413, 415 and signal adjustment circuits 417, 419. In operation, the summing circuit 411 sums an initial current offset signal 421 with an output of the multiplexer 405 to generate the threshold current offset signal 440.

It will be appreciated that although FIG. 4A-FIG. 4C have been described primarily in relation to the threshold current Ith1, further embodiments may include one or more of the features set out in relation to FIGS. 4A-4C for the generation of the threshold current Ith2, (or any further threshold current values) and the control of the multi-phase converter 300 using these threshold currents, in accordance with the understanding of the skilled person.

FIG. 4D is a graph 442 showing the operating efficiency versus the load current Iload (labelled as “I_load”) for a practical implementation of the controller 300 and multi-phase converter 302 of FIG. 3A. In the present example, the threshold currents Ith1, Ith2 vary depending on the input voltage Vin as indicated by the different transition points on the graph 442 for different input voltages. In the present example, the phase transition points ensure optimum operating efficiency across the ensure output load ranges through adjustment of the threshold values as the input voltage changes. There is a shown a trace 444 with transition points optimised for an input voltage of 3.7V; a trace 446 with transition points optimised for an input voltage of 2.5V; and a trace 448 with transition points optimised for input voltages 5.5V. When compared with FIG. 2, it can be observed that embodiments of the present disclosure provide optimised operation irrespective of the input voltage Vin due to the input voltage Vin dependency of the threshold currents Ith1, Ith2 and therefore transition points.

In summary, embodiments of the present disclosure measure input and/or output voltages, and current thresholds relating to the decision points of where to add or shed phases is adjusted.

In summary, embodiments of the present disclosure enable the phase transition points at which the phase circuits of multi-phase converters are enabled/disabled to be adaptively and automatically adjusted depending on input voltage and/or output voltage conditions. In summary, embodiments of the present disclosure implement adaptive phase transition (adding/shedding) thresholds that are responsive not only to output load conditions, but also with input voltage conditions and/or output voltage conditions.

Without such a dependency, a user would have to monitor the input/output voltage conditions and manually adjust the thresholds themselves. Even if the input/output voltage conditions are not wide ranging, it would still be necessary to find the optimal phase transition points and develop dedicated automatic test equipment (ATE) test program (TP) and configuration (written to OTP). Embodiments of the present disclosure provide a simplified system design with improved efficiency compared to known systems. Embodiments of the present disclosure can reduce the effort required for evaluation and test program modification when compared with known systems.

Common reference numerals and variables between Figures represent common features.

Various improvements and modifications may be made to the above without departing from the scope of the disclosure.

1. A controller for a multi-phase switching converter comprising a plurality of phase circuits;
wherein:
the multi-phase switching converter is configured to:
receive an input voltage;
generate an output voltage; and
provide a load current; and
the controller comprising:
a current threshold generator configured to generate a first threshold current that is dependent on the input voltage and/or the output voltage;
a comparator system configured to compare the load current to the first threshold current; and
a phase control system configured to change the number of active phase circuits based on the comparison between the load current and the first threshold current.

2. The controller of claim 1, wherein the first threshold current is dependent on the number of currently active phase circuits.

3. The controller of claim 1, wherein the phase control system is configured to change the number of active phase circuits based on the comparison between the load current and the first threshold current by:
enabling one or more of the phase circuits; and/or
disabling one or more of the phase circuits.

4. The controller of claim 3, wherein the phase control system is configured to change the number of active phase circuits based on the comparison between the load current and the first threshold current by:
enabling one or more of the phase circuits when the load current becomes greater than the first threshold current; and/or
disabling one or more of the phase circuits when the load current becomes less than the first threshold current.

5. The controller of claim 1, wherein:
the current threshold generator is configured to generate a second threshold current that is dependent on the input voltage and/or the output voltage;
the comparator system is configured to compare the load current to the second threshold current; and
the phase control system is configured to change the number of active phase circuits based on the comparison between the load current and the second threshold current.

6. The controller of claim 5, wherein the second threshold current is greater than the first threshold current.

7. The controller of claim 5, wherein:
the first threshold current is dependent on the number of currently active phase circuits; and/or
the second threshold current is dependent on the number of currently active phase circuits.

8. The controller of claim 5, wherein the phase control system is configured to:
change the number of active phase circuits based on the comparison between the load current and the first threshold current by:
enabling one or more of the phase circuits; and/or
disabling one or more of the phase circuits; and
change the number of active phase circuits based on the comparison between the load current and the second threshold current by:
enabling one or more of the phase circuits; and/or
disabling one or more of the phase circuits.

9. The controller of claim 8, wherein the phase control system is configured to:
change the number of active phase circuits based on the comparison between the load current and the first threshold current by:
enabling one or more of the phase circuits when the load current becomes greater than the first threshold current; and/or
disabling one or more of the phase circuits when the load current becomes less than the first threshold current; and
change the number of active phase circuits based on the comparison between the load current and the second threshold current by:
enabling one or more of the phase circuits when the load current becomes greater than the second threshold current; and/or
disabling one or more of the phase circuits when the load current becomes less than the second threshold current.

10. The controller of claim 1, wherein the multi-phase switching converter is a multi-phase buck converter, boost converter, or buck-boost converter.

11. The controller of claim 1, further comprising a voltage sensing unit configured to sense the input voltage and/or the output voltage.

12. The controller of claim 11, wherein the voltage sensing unit comprises a resistor divider configured to sense the input voltage and to provide the sensed input voltage to the current threshold generator.

13. The controller of claim 12, wherein the current threshold generator comprises:
a current regulator configured to receive the sensed input voltage; and
a first current mirror comprising one or more current sources;
wherein:
the first current mirror is coupled to the current regulator; and
the first current mirror is configured to provide the first threshold current to the comparator system.

14. The controller of claim 13, wherein the first current mirror comprises a gain selection transistor for setting a gain value, the first threshold current being dependent on the gain value.

15. The controller of claim 13, wherein the one or more current sources comprises:
a trimming current source for trimming the first threshold current value;
a hysteresis current source configured to adjust the first threshold current based on the number of currently active phase circuits; and/or
a voltage adjustment current source for adjusting the first threshold current based on the output voltage.

16. The controller of claim 15, wherein:
the multi-phase switching converter is configured to generate the output voltage that is dependent on a reference voltage;
the voltage sensing unit comprises a threshold current offset signal generator configured to:
receive the reference voltage, and
generate a threshold current offset signal using the reference voltage; and
the voltage adjustment current source is configured to adjust the first threshold current based on the output voltage using the threshold current offset signal.

17. The controller of claim 15, wherein the phase control system comprises a debouncing circuit configured to control the hysteresis current source.

18. The controller of claim 1, further comprising a current measurement system configured to determine the load current by:
measuring an average current flow in each of the phase circuits;
summing together the average current flows as measured, the load current being the sum of the average current flows as measured; and
providing the load current to the comparator system.

19. The controller of claim 1, wherein:
the multi-phase switching converter is configured to generate the output voltage that is dependent on a reference voltage; and
the current threshold generator is configured to generate the first threshold current that is dependent on the reference voltage and thereby is dependent on the output voltage.

20. A method of controlling a multi-phase switching converter comprising a plurality of phase circuits and being configured to receive an input voltage, generate an output voltage and provide a load current, the method comprising:
generating a first threshold current that is dependent on the input voltage and/or the output voltage using a current threshold generator;
comparing the load current to the first threshold current using a comparator system; and
changing the number of active phase circuits based on the comparison between the load current and the first threshold current using a phase control system.
